(19) United States
(12) Patent Application Publication
(10) Pub. No.: US 2017/0264140 A1
(43) Pub. Date: Sep. 14, 2017

(54) INVERTER FOR INDUCTIVE POWER TRANSMITTER

(71) Applicant: PowerbyProxi Limited, Freemans Bay, Auckland (NZ)

(72) Inventors: Ali ABDOLKHANI, Freemans Bay, Auckland (NZ); Aiguo HU, Freemans Bay, Auckland (NZ)

(21) Appl. No.: 15/039,965

(22) PCT Filed: Nov. 7, 2014
(86) PCT No.: PCT/NZ2014/000231

§ 371 Date: May 27, 2016

(51) Int. Cl. H02J 50/12; H02J 7/02; H02M 1/44; H02M 7/538

(52) U.S. Cl. CPC H02J 50/12; H02M 7/538; H02J 7/025; H02M 1/44; H02M 2001/0048

(57) ABSTRACT

A push-pull inverter for an inductive power transmitter including a DC power supply that supplies power to a first and second branches; a resonant inductor connected between a first node on the first branch and a second node on the second branch; a first switch, switched by a first switching signal, connected between the first node and a common ground; and a second switch, switched by a second switching signal, connected between the second node and the common ground. The first switching signal is based upon the second node when the second node is low and based upon a DC source when the second node is high. The second switching signal is based upon the first node when the first node is low and based upon a DC source when the first node is high.

### FIELD OF THE INVENTION

This invention relates generally to an inverter. More particularly, the invention relates to an inverter of a novel configuration suitable for use in an inductive power transmitter.

### BACKGROUND OF THE INVENTION

Electrical converters are found in many different types of electrical systems. Generally speaking, a converter converts a supply of a first type to an output of a second type. Such conversion can include DC-DC, AC-AC and DC-AC electrical conversions. In some configurations a converter may have any number of DC and AC ‘parts’, for example a DC-DC converter might incorporate an AC-AC converter stage in the form of a transformer.

The term ‘inverter’ may sometimes be used to describe a DC-AC converter specifically. Again, such inverters may include other conversion stages, or an inverter may be a stage in the context of a more general converter. Therefore, the term inverter should be interpreted to encompass DC-AC converters, either in isolation or in the context of a more general converter. For the sake of clarity, the remainder of this specification will refer to the DC-AC converter of the invention by the term ‘inverter’ without excluding the possibility that the term ‘converter’ might be a suitable alternative in some situations.

One example of the use of inverters is in inductive power transfer (IPT) systems. IPT systems will typically include an inductive power transmitter and an inductive power receiver. The inductive power transmitter includes a transmitting coil or coils, which are driven by a suitable transmitting circuit to generate an alternating magnetic field. The alternating magnetic field will induce a current in a receiving coil or coils of the inductive power receiver. The received power may then be used to charge a battery, or power a device or some other load associated with the inductive power receiver. Further, the transmitting coil and/or the receiving coil may be connected to a resonant capacitor to create a resonant circuit. A resonant circuit may increase power throughput and efficiency at the corresponding resonant frequency.

Ordinarily, the transmitting coil or coils are supplied with a suitable AC current generated by an inverter. The inverter may be configured or controlled to generate an AC current of a desired waveform, frequency, phase and amplitude. In some instances, it may be desirable for the frequency of the inverter to match the resonant frequency of the resonant transmitting coil and/or the resonant receiving coil.

One known, type of inverter used in IPT systems is a push-pull inverter. Push-pull inverters typically rely on an arrangement of switches that, by means of co-ordinated switching, cause the current to flow in alternating directions through an associated transmitting coil or coils. By controlling the switches, the output AC current supplied to the transmitting coils can be controlled.

A problem associated with push-pull inverters is that, in order to reduce switching losses and EMI interference, the switches should be controlled to be switched on and off when the voltage across the switch is zero i.e. zero-voltage switching (ZVS). Implementing ZVS often requires additional detection circuitry to detect the zero crossing and control circuitry to control the switches accordingly. This additional circuitry adds complexity and expense to the converter. Further, some detection and control circuitry may not be able to meet the demands of high frequency inverters.

A further problem associated with known inverters is that dedicated startup circuitry is needed to get the circuit started until it reaches a steady state. Again, this adds complexity and cost to the converter.

WO2012145081 discloses a full-bridge power oscillator for a heater. The oscillator includes four switches in a full-bridge configuration that are selectively switched on and off. Additional two switches (normal push-pulls have two) add cost and complexity to the circuit design and control.

Paolucci J “Novel current-fed boundary-mode parallel-resonant push-pull converter” (2009) discloses a DC-DC converter with a ZVS resonant stage. However, the inverter requires an additional DC inductor to supply a quasi-constant DC current to the inverter. DC inductors, as relatively large components, add significant bulk to inverters, in addition to further cost. Further, the resonant stage relies on split resonant inductors, which may not be suitable for IPT systems.

The present invention provides an inverter for an inductive power transmitter that does not rely on complex circuitry to achieve ZVS, an inverter that maintains ZVS at high frequencies, an inverter that does not require dedicated startup circuitry, or at least provides the public with a useful choice.

### SUMMARY OF THE INVENTION

According to one exemplary embodiment there is provided a push-pull inverter for an inductive power transmitter including: a DC power supply that supplies power to a first branch and a second branch; a resonant inductor connected between a first node on the first branch and a second node on the second branch; a first switch, switched by a first switching signal, connected between the first node and a common ground; and a second switch, switched by a second switching signal, connected between the second node and the common ground, wherein the first switching signal is based upon the second node when the second node is low and based upon a DC source when the second node is high, and the second switching signal based upon the first node when the first node is low and based upon a DC source when the first node is high.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any prior art in this specification does not constitute an admission that such prior art forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 shows a general representation of an inductive power transfer system;

FIG. 2 shows an inverter topology according to one embodiment;

FIG. 3 shows waveforms corresponding to the steady-state operation of the inverter of FIG. 2;

FIG. 4 shows waveforms corresponding to the startup operation of the inverter of FIG. 2; and

FIG. 5 shows waveforms corresponding to the steady state operation of the inverter of FIG. 2 across a wide range of frequencies.

### DETAILED DESCRIPTION OF EMBODIMENTS OF THE INVENTION

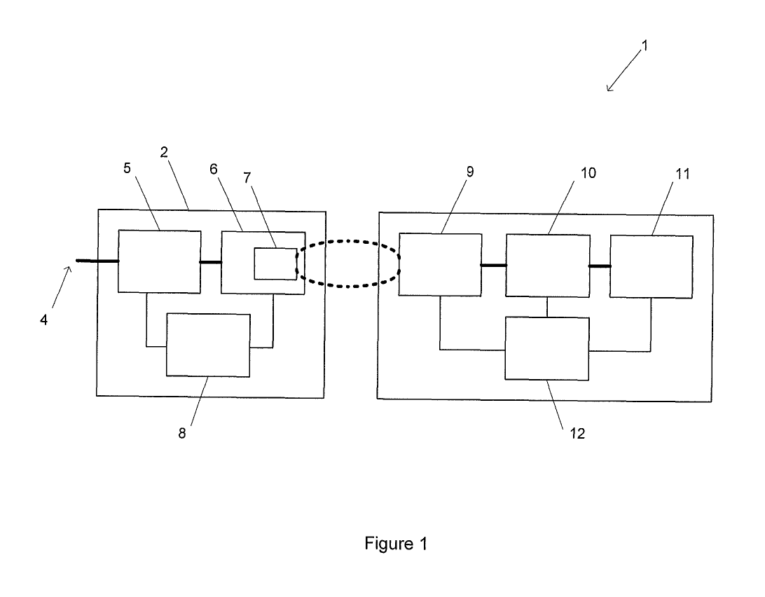

Before discussing the inverter of the present invention, it is helpful to first consider an inductive power transfer (IPT) system. FIG. 1 shows a representation of an IPT system 1. The IPT system includes an inductive power transmitter 2 and an inductive power receiver 3. The inductive power transmitter is connected to an appropriate power supply 4 (such as mains power). The inductive power transmitter may include an AC-DC converter 5 that is connected to an inverter 6. The inverter supplies a transmitting coil or coils 7 with an AC current so that the transmitting coil or coils generate an alternating magnetic field. In some configurations, the transmitting coils may also be considered to be separate from the inverter. The transmitting coil or coils may be connected to capacitors (not shown) either in parallel or series to create a resonant circuit.

FIG. 1 also shows a controller 8 within the inductive power transmitter 2. The controller may be connected to each part of the inductive power transmitter. The controller may be adapted to receive inputs from each part of the inductive power transmitter and produce outputs that control the operation of each part. Those skilled in the art will appreciate that the controller may be implemented as a single unit or separate units. Those skilled in the art will appreciate that the controller may be adapted to control various aspects of the inductive power transmitter depending on its capabilities, including for example: power flow, tuning, selectively energising transmitting coils, inductive power receiver detection and/or communications.

The inductive power receiver 3 includes a receiving coil or coils 9 that is connected to receiving circuitry 10 that in turn supplies power to a load 11. When the inductive power transmitter 2 and inductive power receiver are suitably coupled, the alternating magnetic field generated by the transmitting coil or coils 7 induces an alternating current in the receiving coil or coils. The receiving circuitry is adapted to convert the induced current into a form that is appropriate for the load. The receiving coil or coils may be connected to capacitors (not shown) either in parallel or series to create a resonant circuit. In some inductive power receivers, the receiver may include a controller 12 which may, for example, controlling the tuning of the receiving coil or coils, or the power supplied to the load by the receiving circuitry.

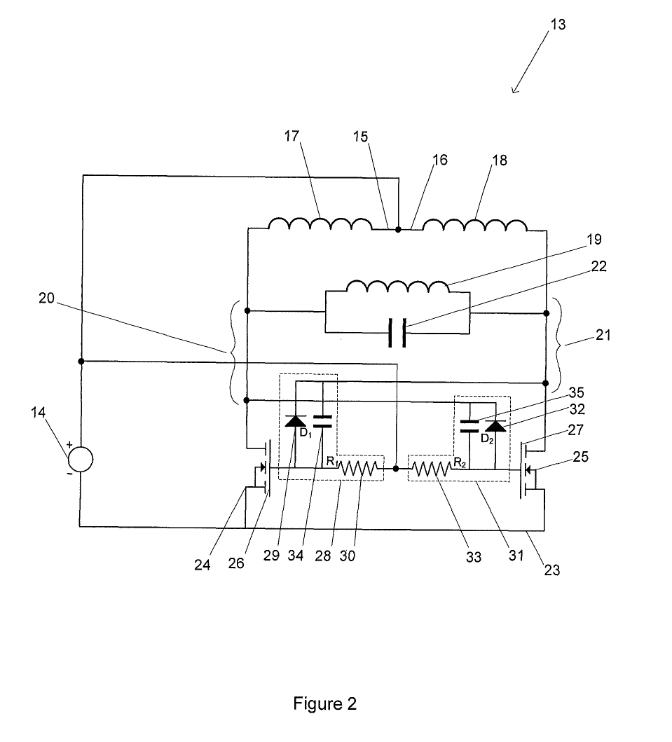

FIG. 2 shows an embodiment of an inverter 13 for an inductive power transmitter according to the present invention. The inverter may be suitable for the general inductive power transmitter 2 as discussed in relation to FIG. 1. However, those skilled in the art will appreciate how the inverter may be suitable for, or adapted to work in, other possible configurations of inductive power transmitters, and the invention should not be limited in this respect.

The inverter 13 includes a DC power supply 14 for supplying DC power to the remainder of the inverter 13. In one embodiment, the DC power supply may be an AC-DC converter (for example, the AC-DC converter 5 as discussed in relation to FIG. 1). The operation of the AC-DC converter may be controlled by a suitable controller. It will be appreciated that the AC-DC converter may be controlled according to the particular requirements of the inductive power transmitter. For example, the AC-DC converter may be controlled so that the current or voltage of the DC power supplied to the inverter meets the power requirements of the inductive power transmitter or the power requirements of an associated inductive power receiver.

The DC power supply 14 supplies current to two branches of a bridge topology. For the sake of clarity these shall be called the first branch 15 and the second branch 16. Each branch includes a DC inductor i.e. a first DC inductor 17 and a second DC inductor 18. The DC inductors divide the average current supplied by the DC power supply in half. It will be appreciated that the effect of the DC inductors is to smooth out the current to make it essentially constant to the rest of the inverter as described in more detail below. That is to say, the inverter is ‘current-fed’. As will be appreciated, these DC inductors are not involved in resonance, and are separate from the resonant tank comprising the resonant inductor and resonant capacitor described below.

The inverter 13 includes a resonant inductor 19 connected between the first branch 15 and the second branch 16 at a first node 20 and a second node 21 respectively. As will be described in more detail below, the switching of a pair of switches causes the direction of the current through the resonant inductor to alternate, resulting in an AC current. The resonant inductor may be connected to a resonant capacitor to create a resonant circuit. In FIG. 2, the resonant inductor is connected in parallel to a resonant capacitor 22. As will be discussed in more detail later, at higher frequencies of operation, the resonant capacitor may be eliminated, with the resonance provided by the capacitance of the pair of switches. In the context of an inductive power transmitter, the resonant inductor may be a transmitting coil or coils.

FIG. 2 also shows a pair of switches connected between the first node 20 and the second node 21 to a common ground 23. For the sake of clarity these shall be called the first switch 24 and the second switch 25 respectively. It will be appreciated by those skilled in the art that if the first switch and the second switch are alternately switched on and off with a 50% duty cycle, there will be a resultant AC current through the resonant inductor 19. In order to ensure each switch is switched on when the voltage across each switch is zero (i.e. zero voltage switch), it is necessary to detect the voltage at either the first node or second node. In FIG. 2, both the first switch and second switch are shown as n-channel MOSFETs which are switched by controlling the voltage at a first gate 26 or a second gate 27 respectively. Those skilled in the art will appreciate how the invention may be adapted for other types of suitable switches, and the invention is not limited in this respect.

Referring to the first switch 24 of FIG. 2, the first gate 26 is connected to a first switching circuit 28. The first switching circuit is adapted to generate a first switching signal for controlling the voltage of the first gate and thus control the switching of the first switch. The first switching circuit includes a first diode 29 connected to the second node 21 and a first current limiting resistor 30 connected to the DC power supply 14.

In operation, when the second node 21 is in a low state (i.e. the second switch 25 is on and thus the second node is connected to ground 23), the first diode 29 is forward biased and thus the voltage at the first gate 26 is also in a low state, so therefore the first switch 24 is off. It will be appreciated that because of the forward bias voltage across the first diode, the voltage at the first gate may not be zero, however depending on the first diode, it will be sufficiently low. That is to say the first switching signal references the state of the second node, and if the state of the second node is low, then the first switching signal is based upon the second node.

However, when the second node 21 is in a high state (i.e. the second switch 25 is off and thus a voltage develops at the second node), the first diode 29 is reverse biased and thus the first switch 24 is drawing current from the first current limiting resistor 30, so the first switch is in a high state (i.e. V_{DC}-V_{R1}). That is to say the first switch signal references the state of the second node, and if the state of the second node is high, then the first switching signal is based upon the DC power supply 14.

Referring to the second switch 25 of FIG. 2, the second gate 27 is connected to a second switching circuit 31. The second switching circuit is adapted to generate a second switching signal for controlling the voltage of the second gate and thus control the switching of the second switch. The second switching circuit includes a second diode 32 connected to the first node 20 and a second current limiting resistor 33 connected to the DC power supply 14.

In operation, when the first node 20 is in a low state (i.e. the first switch 24 is on and thus the first node is connected to ground 23), the second diode 32 is forward biased and thus the voltage at the second gate 27 is also in a low state, therefore the second switch 25 is off. It will be appreciated that because of the forward bias voltage across the second diode, the voltage at the second gate may not be zero, however depending on the second diode, it will be sufficiently low. That is to say the second switching signal references the state of the first node, and if the state of the first node is low, then the second switching signal is based upon the first node.

However, when the first node 20 is in a high state (i.e. the first switch 24 is off and thus a voltage develops at the first node), the second diode 32 is reverse biased and thus the second switch 25 is drawing current from the second current limiting resistor 33, so the second switch is in a high state (i.e. V_{DC}-V_{R2}). That is to say the second switch signal references the state of the first node, and if the state of the first node is high, then the second switching signal is based upon the DC power supply 14.

Simply, when the first switch 24 is switched off, this causes a higher voltage to develop at the first node 20. Since the first node is high, the second switch 25 is switched on, so the second node 21 is low. When the first node goes low, the second switch is switched off, which causes a voltage to develop at the second node. Since this second node is high, the first switch is switched on so the first node is low.

It will be appreciated that the net effect of the first switching circuit 28 and the second switching circuit 31 is that the first switch 24 and second switch 25 are effectively cross-coupled, with each switch alternately switching off and on with a 50% duty cycle. It will be further appreciated that since the switching of the switches is dependent on the voltage at the nodes 20 21, there is zero-voltage switching.

The waveforms related to the steady-state operation of the circuit will be discussed in more detail later.

The diodes 29 32 of the inverter 13 may be any suitable asymmetric current flow device. In one embodiment the diodes may be Schottky diodes so as to cope with the fast switching and low voltage drop required by a high frequency inverter. The diodes may include parallel capacitors to act as speedup capacitors. FIG. 2 shows a first speedup capacitor 34 and a second speedup capacitor 35 associated with the first diode 29 and second diode 32 respectively. It will be appreciated that such speedup capacitors speed up the switching on of the switches. Again, this may be particularly desirable when fast switching is required in a high frequency inverter.

In FIG. 2, the first switching circuit 28 and second switching circuit 31 are connected to the DC power supply 14 so that the first switching signal and second switching signal are based on the voltage of the DC power supply. It will be appreciated that any DC source may be suitable. In some embodiments where the DC power supply has a high input voltage it may be preferable to have a separate DC source (not shown in FIG. 2) connected to the first switching circuit and the second switching circuit. For example, in case of high power IPT systems, the DC power supply may need to supply power to the inverter at a voltage that is too high for the switches, and therefore a separate DC power source connected to the switches may be suitable.

Those skilled in the art will appreciated how the relative sizes of the components will need to be selected based on the requirements of the particular inverter, and the invention is not limited in this respect. The inverter circuit may be configured with consideration given to at least some of the following factors: the DC power source, the types of switches used, the types of diodes used, the size of the speed limiting resistors, the size of the speed-up capacitors, the size of the resonant inductor, power loss tolerances, switching frequencies, and the desired waveform of the AC current.

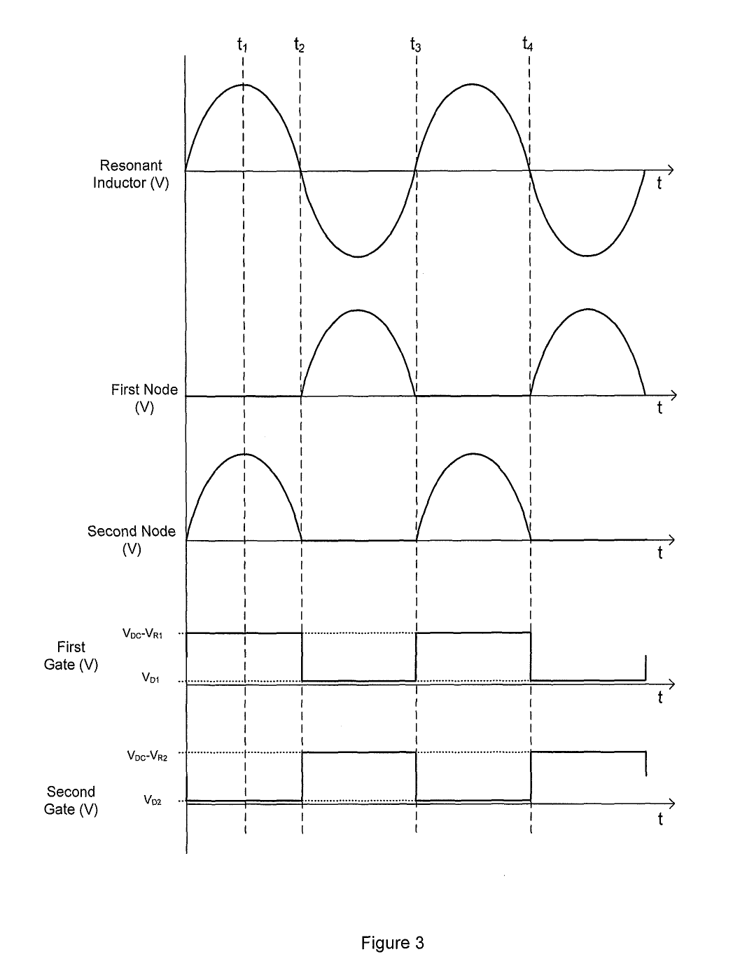

FIG. 3 shows waveforms associated with the steady-state operation of the inverter of FIG. 2.

At time t₁, the voltage at the second node is high, so therefore the first gate voltage is based on the DC power supply, and is therefore V_{DC}-VR₁. Since the first gate voltage is high, the first switch is on, and therefore the first node is connected to ground. Since the state of the first node is low, the second diode is forward biased, and therefore the second gate voltage is V_{D2}, and the second switch is off.

At time t₂, the voltage at the second node (and across the resonant inductor) reaches zero. At this stage, the first diode becomes forward biased so the first diode voltage is V_{D1} and the first switch is switched off. Since the first switch is off, a voltage will develop at the first node. Since the voltage at the first node is high, the second diode will be reverse biased and the second gate voltage will be based on the DC power supply, and is therefore V_{DC}-VR₂.

At time t₃, the voltage at the first node (and across the resonant inductor) reaches zero. At this stage, the second diode becomes forward biased so the second diode voltage is V_{D2} and the second switch is switched off. Since the second switch is off, a voltage will develop at the second node. Since the voltage at the second node is high, the first diode will be reverse biased and the first gate voltage will be based on the DC power supply, and is therefore

V_{DC}-VR₁.

At time t₄, the same situation as time t₂ applies. Thus the cycle of switching will be repeated. It will be appreciated from the waveforms of FIG. 3 that the operation of the first switching circuit and the second switching circuit maintain zero voltage switching. For example, the first switch will only be switched off once the second switch has been switched on (which in turn requires the voltage across the first switch to be zero). Further, the switching of the first switch and second switch is completely autonomous, not requiring a dedicated controller to detect zero-crossings or to control the gate signals. The inverter will self-sustain its operation so long as there is DC power supplied to the inverter.

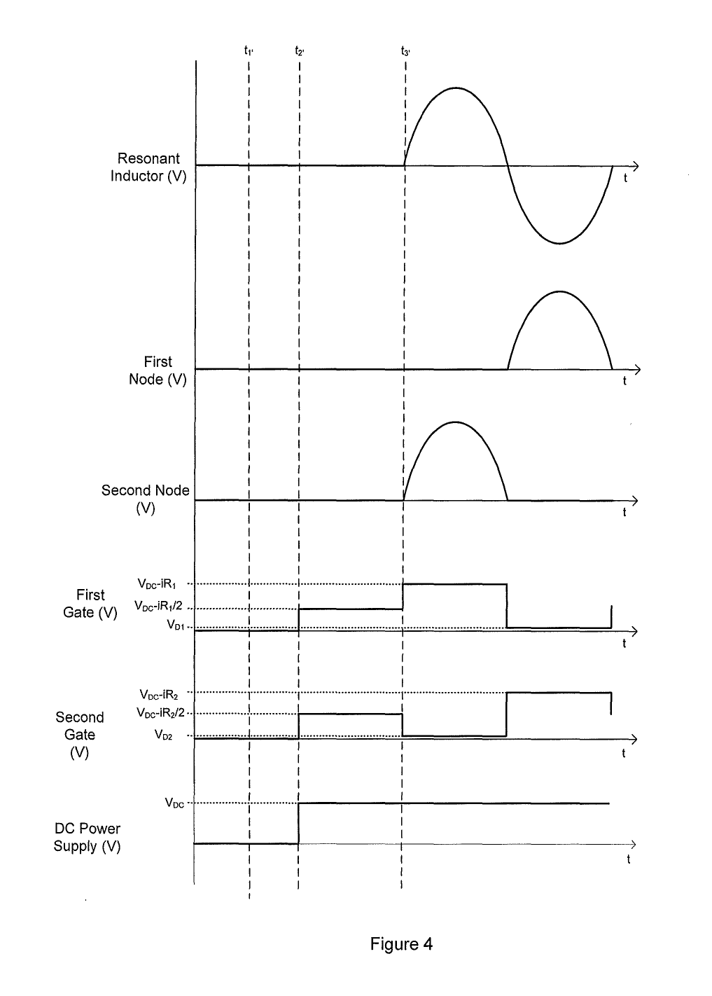

The inverter of the present invention does not require complex startup circuitry and can startup automatically. FIG. 4 shows example waveforms during startup. To start at time t_{1′}, both switches are turned off. At time t_{2′},the DC power supply is then switched on. Since both the first node and the second node are low, the first gate voltage and the second gate voltage will be based on the DC power supply (V_{DC}-iR/2), and both switches will turn on. The current from the DC power supply will then build up in the DC inductors. At some point (time t_{3′}), a first zero crossing will be detected by either the first diode or the second diode (as shown in FIG. 4). This will then cause the gate voltage for that switch to go low, and for that switch to turn off (e.g. the second switch in FIG. 4). The gate voltage of the other switch will increase (to V_{DC}-iR, i.e. V_{DC}-V_{R}) and that switch will remain on (e.g. the first switch in FIG. 4). From which the normal operation of the inverter as shown in FIG. 3 will continue. It will be appreciated that this startup method does not require dedicated startup circuitry.

Since the switching on of the switches of the inverter described above is driven directly by the DC power supply (or some separate DC source) via the two current limiting resistors (i.e. 30 33 in FIG. 2), and the switching off is achieved by active shorting of the switches (i.e. 24 25 in FIG. 2) via the diodes (i.e. 29 32 in FIG. 2), the quality of switching signal can be maintained at a higher frequency without high power losses associated. Thus the inverter is able to operate under high frequency conditions. In one embodiment, the inverter may operate from low frequencies within the kHz range, e.g., from about 1 kHz to about 1000 kHz, up to high frequencies within the MHz range, e.g., up to about 10 MHz to about 100 MHz. Further, at such high frequencies, it may be possible to eliminate the separate resonant capacitor connected to the resonant inductor, with the output capacitance of the first switch and the second switch being used instead to resonate with the resonant inductor.

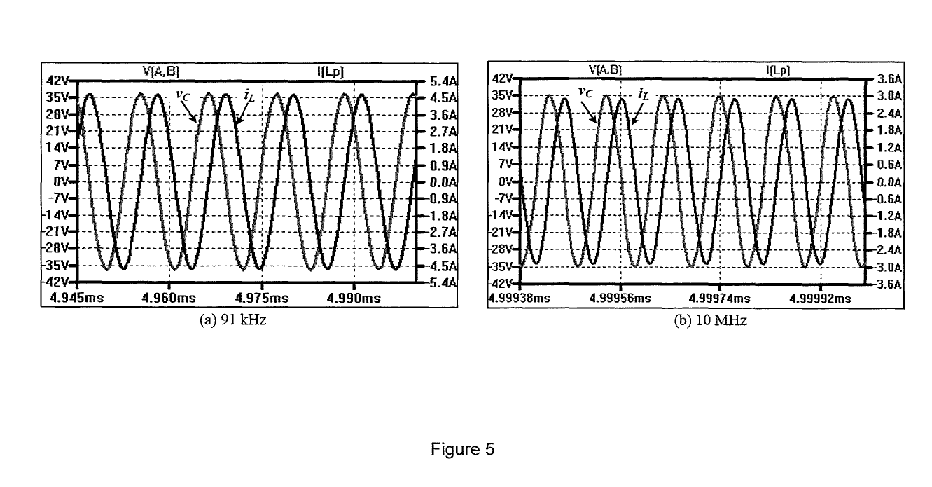

For example, FIG. 5 shows waveforms corresponding to the steady state operation at 91 kHz and 10 MHz respectively. The waveforms show the voltage across the resonant inductor (v_{C}) and the current through the resonant inductor (i_{L}). As will be seen, the increase in frequency has little effect on the quality of the output waveform.

It will be appreciated that the inverter described above achieves ZVS, even at high frequencies, without relying on separate circuitry to detect zero-crossings and to control the switches. Further, since there is no separate circuitry, the inverter is autonomous, self-sustaining its operation. Finally, the inverter has a simple startup procedure not requiring separate dedicated startup circuitry.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A push-pull inverter for an inductive power transmitter including:
a. a DC power supply that supplies power to a first branch and a second branch;
b. a resonant inductor connected between a first node on the first branch and a second node on the second branch;
c. a first switch, switched by a first switching signal, connected between the first node and a common ground; and
d. a second switch, switched by a second switching signal, connected between the second node and the common ground,
wherein the first switching signal is based upon the second node when the second node is low and based upon a DC source when the second node is high, and the second switching signal based upon the first node when the first node is low and based upon a DC source when the first node is high.

2. The push-pull inverter as claimed in claim 1, wherein the DC source is the DC power supply.

3. The push-pull inverter as claimed in claim 1, wherein the first branch and the second branch each include a DC inductor, which are not part of the resonant inductor.

4. The push-pull inverter as claimed in claim 1, wherein the resonant inductor is connected in parallel to a resonant capacitor.

5. The push-pull inverter as claimed in claim 1, wherein the resonant inductor is resonant with the capacitances of the first switch and the second switch.

6. The push-pull inverter as claimed in claim 1, wherein the resonant inductor forms a transmitting coil of the inductive power transmitter.

7. The push-pull inverter as claimed in claim 1, wherein the frequency of operation is from about 1 kHz to up to about 100 MHz.

8. The push-pull inverter as claimed in claim 7, wherein the frequency of operation is up to about 10 MHz.

9. The push-pull inverter as claimed in claim 1, wherein a first gate of the first switch is connected to the second node by a first diode, such that when the first diode is forward biased, the first gate is driven by the second node and when the first diode is reverse biased, the first gate is driven by the DC source, and wherein a second gate of the second switch is connected to the first node by a second diode, such that when the second diode is forward biased, the second gate is driven by the first node and when the second diode is reverse biased, the second gate is driven by the DC source.

10. The push-pull inverter as claimed in claim 9, wherein the first diode is connected in parallel to a first speedup capacitor and the second diode is connected in parallel to a second speedup capacitor.
